(19) United States
(12) Patent Application Publication
(10) Pub. No.: US 2009/0044509 A1
(43) Pub. Date: Feb. 19, 2009

(54) Crop guard with staggered guide fingers

(76) Inventor: Keith M. Deines, Ransom, KS (US)

Correspondence Address: D.A.N Chase;Chase Law Firm, L.C., 800 W. 47th Street, Suite 401, Kansas City, MO, 64112, US

(21) Appl. No.: 12/220,889

(22) Filed: Jul. 29, 2008

Related U.S. Application Data
(60) Provisional application No. 60/962,576, filed on Jul. 30, 2007.

(51) Int. Cl. A01D 34/18; A01D 41/14; A01D 34/40

(52) U.S. Cl. 56/298

(57) ABSTRACT

A row of transversely spaced guide fingers projects forwardly from the header of a harvesting machine to permit flow of the crop between the fingers into the sickle, wherein adjacent pairs of the fingers are staggered in length and present a space therebetween having a transverse width of at least approximately forty percent of the center-to-center width of adjacent pairs of fingers to thereby enhance free crop flow and minimize loss of severed, grain-bearing heads.

### CROSS REFERENCE TO RELATED APPLICATION

This application claims the benefit of a prior filed, co-pending application Ser. No. 60/962,576, filed Jul. 30, 2007, entitled CROP GUARD WITH STAGGERED GUIDE FINGERS.

### FIELD OF THE INVENTION

This invention relates to agricultural equipment for harvesting a standing crop such as corn, milo, sunflowers, oats, barley or soybeans and, more particularly, to apparatus for guiding the crop into the sickle of a harvesting machine.

### BACKGROUND OF THE INVENTION

Harvesting machinery such as combines are typically provided with a header at the front of the machine which employs a laterally extending, horizontal sickle to sever the grain-bearing stalks which then flow into the harvester where the grain is separated from the residue. In order to guide the crop into the header and thereby maximize grain flow and minimize losses, a row of forwardly extending, spaced guide plates may be attached to the forward portion of the frame of the harvesting machine so as to define passageways between the plates leading rearwardly to the sickle. Apparatus of this general type is set forth, for example, in U.S. Pat. No. 5,105,610 wherein guide plates are spaced laterally from one another so as to define elongated, narrow passageways between them leading rearwardly to the sickle. However, the guide plates may interfere with crop flow, particularly in high population crops such as milo, resulting in loss of grain due to uncut stalks that are pushed over by the fingers and pass beneath the sickle.

### SUMMARY OF THE INVENTION

In an embodiment of the present invention, the aforementioned problem is addressed by providing a row of transversely spaced guide fingers projecting forwardly from the header of a harvesting machine to permit flow of the crop between the fingers into the sickle, wherein adjacent pairs of the fingers are staggered in length and present a space therebetween having a transverse width of at least approximately forty percent of the center-to-center width of adjacent pairs of fingers to thereby enhance free crop flow and minimize loss of the severed, grain-bearing heads.

In another aspect of the invention, the shorter fingers of the row of guide fingers are approximately seventy to eighty percent of the length of the longer fingers.

Further aspects of the invention include providing a center-to-center width of adjacent pairs of fingers of approximately three to four inches, providing a spacing between adjacent fingers of approximately one and one-half to two inches, and orienting the forwardly projecting guide fingers to extend downwardly at an angle of approximately ten to fourteen degrees from the direction of movement of the harvesting machine to thereby lift the crop and maximize severing of the stalks.

Another aspect of the present invention is the mounting of the guide fingers by providing a lower, elongated support component for each finger secured to a corresponding sickle guard and projecting forwardly and downwardly therefrom, and an upper finger component on the support component for lifting the crop as the harvesting machine advances.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a partial, perspective view of the front of a combine showing the guide fingers of the present invention extending forwardly from the sickle.

FIG. 2 is a plan view of a first embodiment of a guide finger unit having a series of transversely spaced, forwardly extending guide fingers of staggered lengths mounted on a common support member.

FIG. 3 is a plan view similar to FIG. 2 but showing a second embodiment of a guide finger unit having wider fingers.

FIG. 4 is a plan view of the first embodiment showing the guide finger unit overlying the sickle in its operational position with the fingers projecting forwardly therefrom.

FIG. 5 is a plan view of the second embodiment showing the sickle guards received in respective support eyes on the guide finger unit, the sickle being removed for clarity.

FIG. 6 is an exploded, side view of one of the fingers of the second embodiment showing the lower, angle iron arm component of the finger spaced beneath the upper, plastic finger component.

FIG. 7 is similar to FIG. 6 but with the two components bolted together, illustrating the mounting of the unit on the sickle guards.

FIG. 8 is a detail, plan view of the plastic finger component.

### DETAILED DESCRIPTION

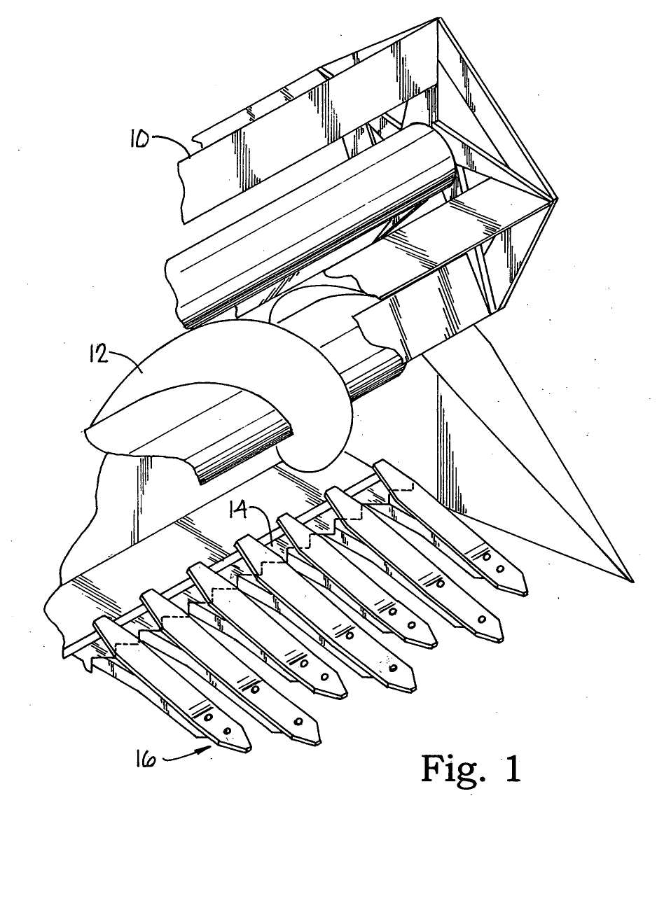

Referring initially to FIG. 1, the header of a combine is partially shown and comprises, as standard components, a rotatable reel 10, an auger 12 below the reel 10 extending parallel thereto and having the usual converging components for feeding the cut crop to the center of the combine header to discharge the severed, grain-bearing heads rearwardly to the elevator (not shown) of the combine, a sickle 14 in front of and beneath the auger 12, and a row of forwardly extending, transversely spaced guide fingers 16 projecting forwardly from the sickle 14 as will be described in detail hereinbelow. As is apparent, the guide fingers 16 are spaced apart and have staggered lengths.

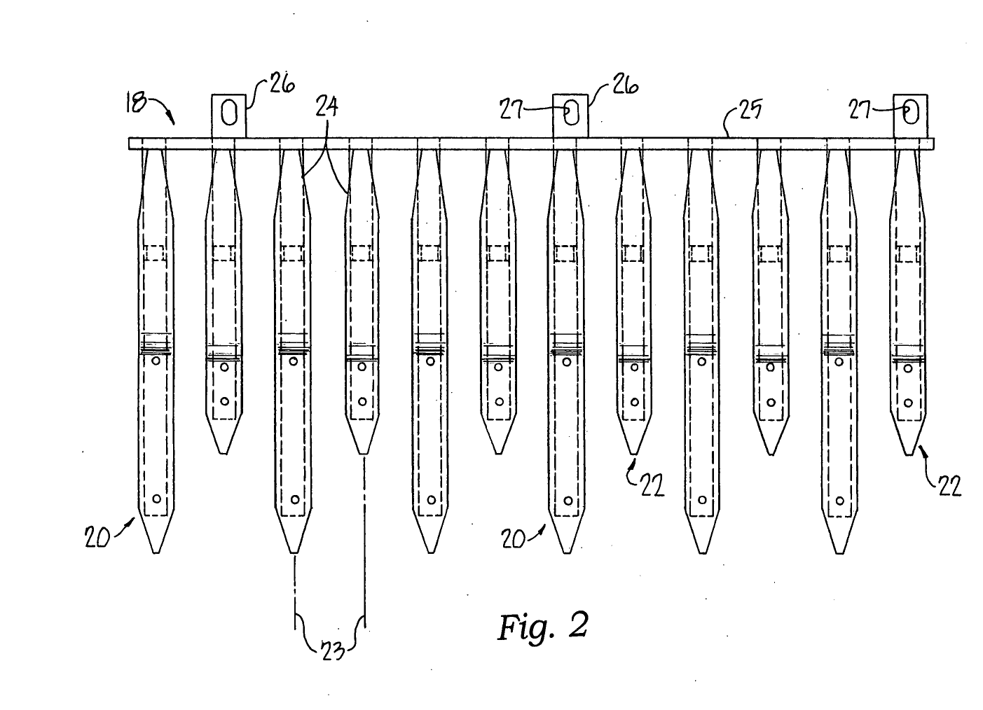

The row of guide fingers 16 comprises a series of end-to-end guide finger units, one such unit 18 being shown in FIG. 2. Unit 18 comprises six long fingers 20 and six short fingers 22 arranged in alternating fashion as is clear in FIG. 2, and each tapered to a point at its forward end. The fingers in 20, 22 are spaced, for example, approximately three inches apart between the longitudinal centerlines 23 of adjacent fingers. The rear ends 24 of the fingers are secured to a common support member provided by a metal bar 25 having spaced, rearwardly projecting tabs 26 with apertures 27 therein thereby providing a mounting structure to secure the unit 18 to the combine by bolts (not shown) through the tabs 26 and a front frame member or platform (not shown) of the combine. It should be noted in the embodiment of FIG. 2 that the spacing between adjacent fingers 20, 22 is essentially equal to the width of each finger.

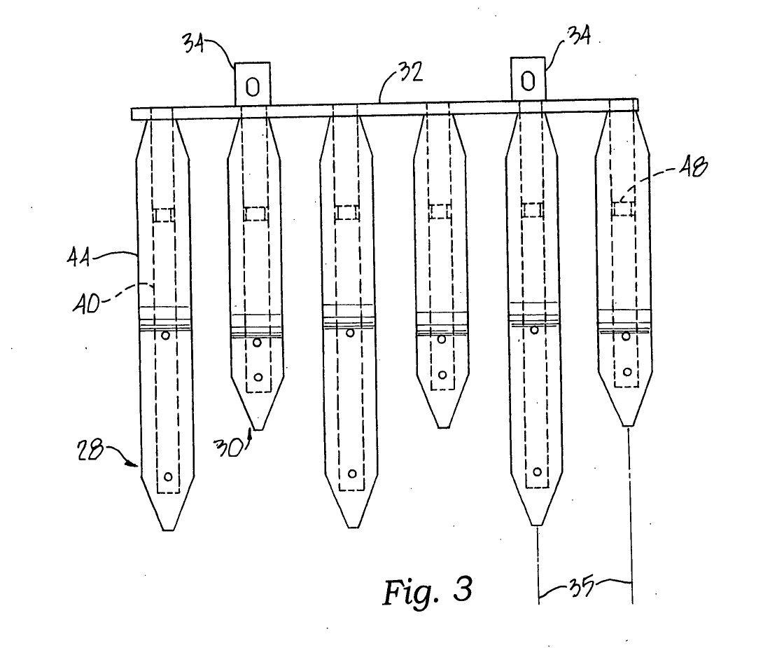

A similar arrangement is shown in FIG. 3 wherein alternating long and short fingers 28 and 30 respectively are secured at their rear ends to a mounting bar 32 provided with rearwardly extending tabs 34 having apertures therein to permit the structure to be bolted to the platform of the combine. The wider, staggered fingers 28 and 30 shown in FIG. 3 are, for example, spaced approximately four inches between adjacent centerlines 35.

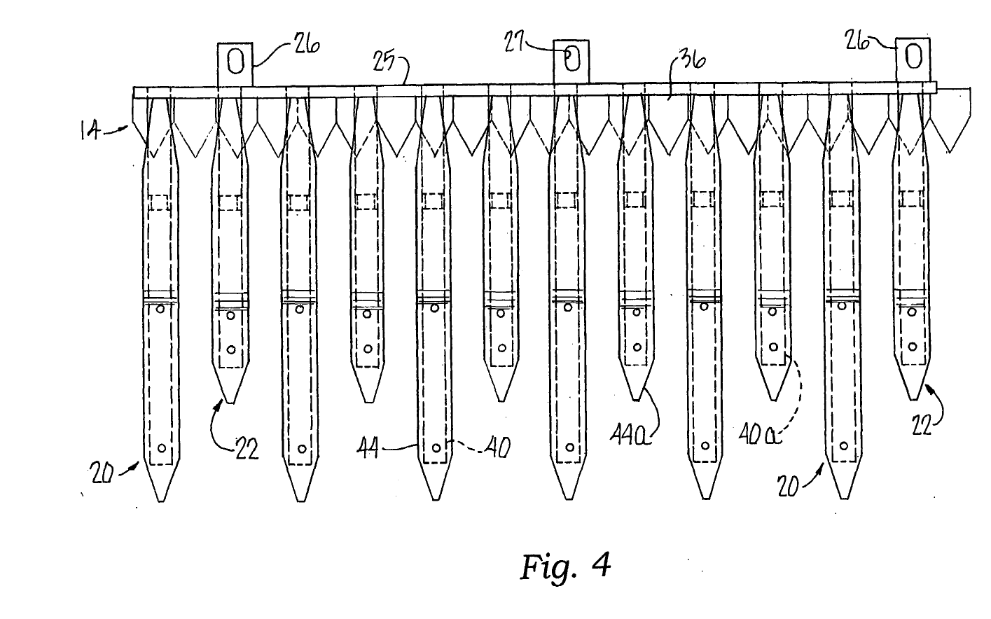

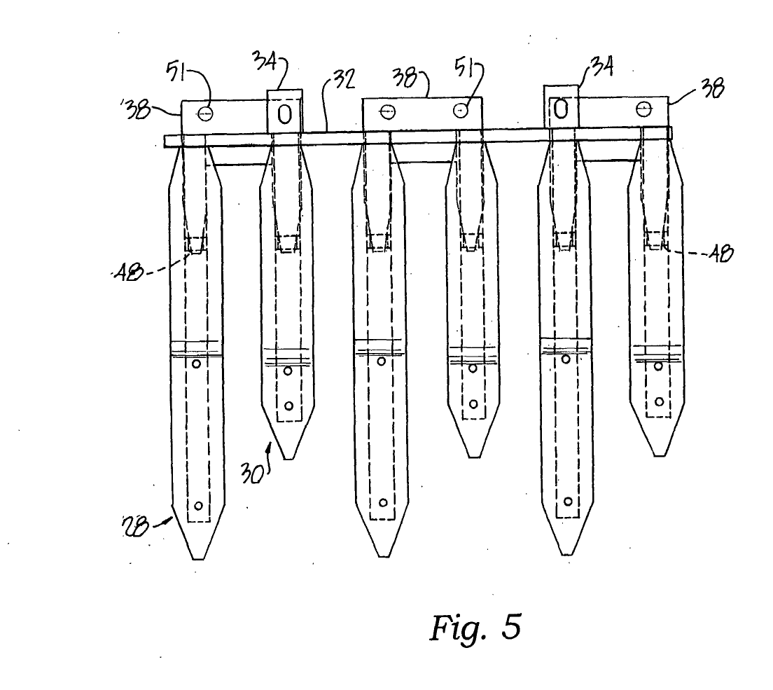

FIG. 4 is similar to FIG. 2 with the addition of sickle 14 which presents a row of side-by-side sickle sections 36. As is conventional, the sickle reciprocates within associated sickle guards 38 (FIG. 5) spaced along the sickle. The sickle guards are removed in FIG. 4 for clarity.

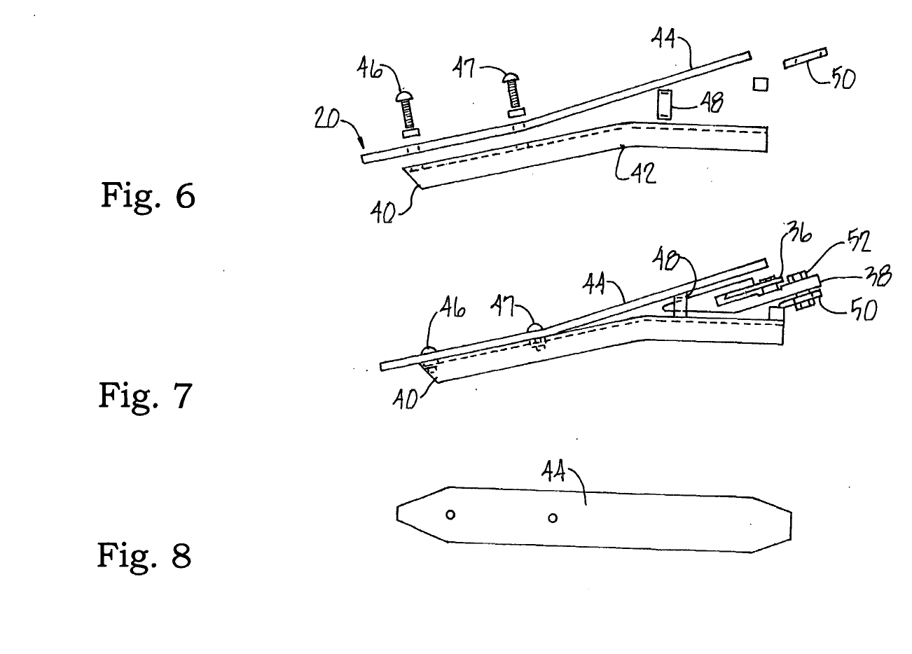

Referring now to FIGS. 6 and 7, it may be appreciated that each of the fingers 20, 22 and 28, 30 of the present invention comprises two components as best seen in FIGS. 6 and 7 where one of the fingers 20, for example, is illustrated. The lower component of the finger 20 comprises an elongated angle iron 40 having a bend 42 from horizontal of approximately 12 degrees. The upper finger component 44 is composed of a plastic material and is secured to the angle arm component 40 by a pair of bolts 46 and 47. The upper, plastic component 44 diverges from the angle iron component 40 behind bolt 47 and is held in spaced relationship thereto by a support eye 48 welded on component 40 which receives and holds one of the pointed, forward ends of a respective sickle guard 38 (FIGS. 5 and 7). The rear (right as viewed in FIG. 7) end of the angle iron arm component 40 has a rearwardly extending tab 50 through which a bolt 52 extends and is secured by a nut, as seen in FIG. 7. Bolts 52 (not shown in FIG. 5) extend through mounting holes 51 in the rear flange of each of the sickle guards 38. Accordingly, the guide finger assemblies of the present invention are securely mounted on the sickle guards 38 of the combine and extend forwardly and downwardly to lift the crop and maximize severing of the stocks and, therefore, harvest of the grain-bearing heads. Although a 12-degree bend from horizontal is preferred, an angle of approximately 10 to 14 degrees may be selected.

Furthermore, the spacing and orientation of the guide fingers enhance free crop flow and minimize loss of severed, grain-bearing heads. In the first embodiment of FIGS. 2 and 4, the preferred spacing between adjacent fingers is approximately one and one-half inches which, together with the approximately three inch spacing between the longitudinal centerlines 23, provides the enhanced crop flow and, furthermore, minimizes any tendency of the fingers to push uncut stalks beneath the sickle sections 36 which would result in loss of grain due to uncut stalks. The staggered fingers 28 and 30 in the embodiment of FIGS. 3 and 5 likewise minimize uncut stalks due to the wider, approximately four inch center-to-center spacing 35 which provides a distance between adjacent fingers 28 and 30 of approximately one and three-quarter inches.

In summary, the staggered lengths of the guide fingers and wide spacing (approximately 1½-1¾ inch) permit heavier crop flow without knocking over the stalks before they are severed by the sickle. The downwardly extending angle of the fingers lifts the crop to maximize severing of the stalks and thus harvest of the grain-bearing heads. The staggered fingers of the present invention are readily attached to a combine and stabilized by interfitting with the sickle guards as shown in FIG. 7 and described above. Free flow of the crop into the sickle is enhanced and loss of severed, grain-bearing heads is minimized.

It should be understood that while certain forms of the invention have been illustrated and described, it is not limited thereto except insofar as such limitations are included in the following claims.

Having thus described the invention, what is claimed as new and desired to be secured by Letters Patent is:

1. In combination with a header of a harvesting machine:
a sickle extending laterally along said header,
a row of transversely spaced guide fingers projecting forwardly from said header for crop flow therebetween into the sickle, adjacent pairs of said fingers being staggered in length, and
each adjacent pair of said fingers presenting a space therebetween at least approximately forty percent of the center-to-center width of said adjacent pair of fingers, whereby to enhance free crop flow and minimize loss of severed, grain-bearing heads.

2. The combination as claimed in claim 1, wherein a shorter finger of said adjacent pairs is approximately 70 to 80 percent of the length of a longer finger thereof.

3. The combination as claimed in claim 1, wherein said center-to-center width is approximately three to four inches.

4. The combination as claimed in claim 3, wherein the space between adjacent fingers is approximately one and one-half to two inches.

5. The combination as claimed in claim 1, wherein said forwardly projecting guide fingers extend downwardly at an angle of approximately ten to fourteen degrees from a direction of movement of the harvesting machine, whereby to lift a crop and maximize severing of the stocks.

6. The combination as claimed in claim 5, wherein said angle is approximately twelve degrees.

7. The combination as claimed in claim 6, wherein a shorter finger of each of said adjacent pairs is approximately 70 to 80 percent of the length of a longer finger thereof.

8. The combination as claimed in claim 1, further comprising a plurality of sickle guards spaced along said sickle, each of said fingers including a lower, elongated support component secured to a corresponding sickle guard and projecting forwardly and downwardly therefrom, and an upper finger component on said support component for lifting the crop as the harvesting machine advances.
